(19) United States
(12) Patent Application Publication
(10) Pub. No.: US 2008/0080488 A1
(43) Pub. Date: Apr. 3, 2008

(54) Methods, systems, and computer program products for enabling short code dialing in an ENUM environment

(75) Inventor: Peter J. Marsico, Chapel Hill, NC (US)

Correspondence Address: JENKINS, WILSON, TAYLOR & HUNT, P. A., 3100 TOWER BLVD., Suite 1200, DURHAM, NC, 27707, US

(73) Assignee: Tekelec

(21) Appl. No.: 11/904,298

(22) Filed: Sep. 26, 2007

Related U.S. Application Data
(60) Provisional application No. 60/847,742, filed on Sep. 28, 2006.

(51) Int. Cl. H04L 12/66

(52) U.S. Cl. 370/352

(57) ABSTRACT

Methods, systems, and computer program products for enabling short code dialing in an ENUM environment are provided. According to one method, an ENUM query message that includes a calling party identifier and a called party short code identifier is received. An ENUM translation is performed to locate at least one URI corresponding to the calling party identifier and the called party short code identifier. The ENUM query message is responded to with the at least one URI.

### RELATED APPLICATIONS

This application claims the benefit of U.S. Provisional Patent Application Ser. No. 60/847,742, filed Sep. 28, 2006; the disclosure of which is incorporated herein by reference in its entirety.

### TECHNICAL FIELD

The subject matter described herein relates to methods and systems for enabling short code dialing in a public communications network. More particularly, the subject matter described herein relates to methods and systems for providing ENUM or ENUM-like domain name service (DNS) service for communications directed to a called party short code in a public communications network environment.

### BACKGROUND

In wireline telecommunications networks, private branch exchanges (PBXs) are scaled-down versions of central office switches owned by private organizations (versus a public telephone company). One feature provided by PBXs is to allow members of the subscriber group serviced by the PBX to dial shortened versions (referred to as short codes) of other member's full E.164 directory numbers. An E.164 formatted number is typically between 10 and 15 digits in length and may include a country code identifier component, a national destination code identifier component, and identification code component, and a subscriber number component, depending upon the particular network implementation. In the United States, these short dialing codes are typically the last four digits of the seven- or ten-digit E.164 telephone number. Using these short dialing codes eliminates the need for group members to remember full seven- or ten-digit E.164 telephone numbers in order to contact other group members. It will be appreciated that a PBX-based short code is relevant only within the context of the particular private branch exchange that hosts the corresponding full digit number. In other words, a call to the PBX-based short code could not be successfully completed if dialed by a subscriber who is being served by a public switched telephone network (PSTN) end office or mobile switching center.

Commonly assigned U.S. Pat. No. 7,072,678 discloses methods and systems for enabling short code dialing in a public communications network, such as a GSM or IS-41 wireless network. One key attribute of a short code that is used for mobile group dialing is that the short code is not necessarily a unique within a network. That is, subscriber A may define and a short code 111 that is associated with subscriber B, and subscriber C may define the same short code value, 111, to be associated with subscriber D. This is, of course, is not the case for conventional, public full-digit dialing/numbering plans, where each full-digit dialable number is uniquely associated with a single subscriber.

In recent years, the Internet Engineering Task Force (IETF) initiated the development of the E.164 Number Mapping (ENUM) system for facilitating the interconnection of communications networks that rely on telephone numbers with the communications networks that utilize the Domain Name System (DNS). A detailed description of ENUM service can be found in IETF RFC 3761, April 2004 The E.164 to Uniform Resource Identifiers (URI) Dynamic Delegation Discovery System (DDDS) Application (ENUM), the disclosure of which is incorporated herein by reference in its entirety. In particular, an ENUM system can map a particular number referred to as an E.164 number to one or more Uniform Resource Identifiers (URIs) in the DNS. URIs are strings of characters that identify resources such as documents, images, files, databases, e-mail addresses, websites or other resources or services in a common structured format. A URI can include a SIP URI, an instant messaging (IM) identifier, an e-mail address identifier, an Internet chat session identifier, and an IP address.

ENUM translations are based on the full directory number being dialed. Accordingly, an ENUM translation based on a short code would likely fail. In addition, because ENUM service translates public DNs into public URIs and because short codes typically only have meaning in private networks, short codes alone cannot be used where the called endpoint is identified by a public URI.

Accordingly, in light of these difficulties associated with short code dialing, there exists a need for improved methods and systems for providing short code dialing functionality in a communications network environment that includes ENUM translation service.

### SUMMARY

Methods, systems, and computer program products for enabling short code dialing in an ENUM environment are provided. According to one method, an ENUM query message that includes a calling party identifier and a called party short code identifier is received. An ENUM translation is performed to locate at least one URI corresponding to the calling party identifier and the called party short code identifier. The ENUM query message is responded to with the at least one URI.

According to one aspect of the subject matter described herein, a network element, such as a signaling system 7 (SS7) signal transfer point (STP), an SS7-Internet protocol (IP) signaling gateway (SG), or a flexible ENUM routing function (E-Flex) routes call signaling messages between entities in a communications network environment and receives or intercepts ENUM query messages that contain short dialing codes. The network element includes or has access to a short code resolution (SCR) function, which is adapted to examine a called party short code address value and a calling party address value contained in an ENUM query message. The SCR function is adapted to use the called party short code address and calling party address information to access a short code resolution database and resolve the called party short code address into a fully specified subscriber address (e.g., E.164 formatted telephone number). The resolved, fully specified subscriber address is inserted into the ENUM query message, and the ENUM query message is forwarded to an ENUM application for ENUM translation processing.

According to another aspect, the subject matter described herein includes an ENUM application that is adapted to receive an ENUM query message that contains a called party short code address value and a calling party address value. The ENUM application is adapted to use the called party short code address and calling party address information to access a short code resolution database and resolve the called party short code address into a fully specified subscriber address (e.g., E.164 formatted telephone number). The resolved, fully specified subscriber address is used by the ENUM application to perform ENUM translation processing.

According to yet another aspect, the subject matter described herein includes a short code-enabled ENUM application. In this embodiment, an ENUM query that includes a called party short code address value and a calling party address value is received by the ENUM application. The ENUM application is adapted to use the called party short code address and calling party address information to access short code-adapted ENUM translation data, and thereby resolve the called party short code address into one or more URI values, which are returned to the ENUM query originator.

The subject matter described herein for providing short code adapted ENUM service may be implemented using a computer program product comprising computer executable instructions embodied in a computer readable medium. Exemplary computer readable media suitable for implementing the subject matter described herein includes disk memory devices, programmable logic devices, and application specific integrated circuits. In one exemplary implementation, a computer program product that implements the subject matter described herein may include a memory accessible by a processor. The memory may store the above-referenced short code resolution function for resolving short codes and calling party numbers into full directory numbers and/or URIs. In addition, a computer readable medium that implements the subject matter described herein may be distributed across multiple physical devices and/or computing platforms.

### BRIEF DESCRIPTION OF THE DRAWINGS

Preferred embodiments of the subject matter described herein will now be described with reference to the accompanying drawings of which:

FIG. 1 is a network diagram illustrating a short code adapted ENUM system that includes an E-Flex node-based short code resolution function and an external short code resolution database according to an embodiment of the subject matter described herein;

FIG. 2 is a block diagram, which illustrates an exemplary embodiment of an E-Flex node that includes a short code resolution function;

FIG. 3 is a network diagram illustrating a short code adapted ENUM system that includes an E-Flex node-based short code resolution function and an internal short code resolution database according to an embodiment of the subject matter described herein;

FIG. 4 is a block diagram, which illustrates an exemplary embodiment of an E-Flex node that includes a short code resolution function and a short code resolution database according to an embodiment of the subject matter described herein;

FIG. 5 is a network diagram illustrating a short code adapted ENUM system that includes an ENUM node-based short code resolution function and an external short code resolution database according to an embodiment of the subject matter described herein;

FIG. 6 is a block diagram, which illustrates an exemplary embodiment of an ENUM node that includes a short code resolution function according to an embodiment of the subject matter described herein;

FIG. 7 is a network diagram illustrating a short code adapted ENUM system that includes an short code adapted ENUM application according to an embodiment of the subject matter described herein; and

FIG. 8 is a block system diagram, which illustrates an exemplary embodiment of a short code adapted ENUM node according to an embodiment of the subject matter described herein.

### DETAILED DESCRIPTION

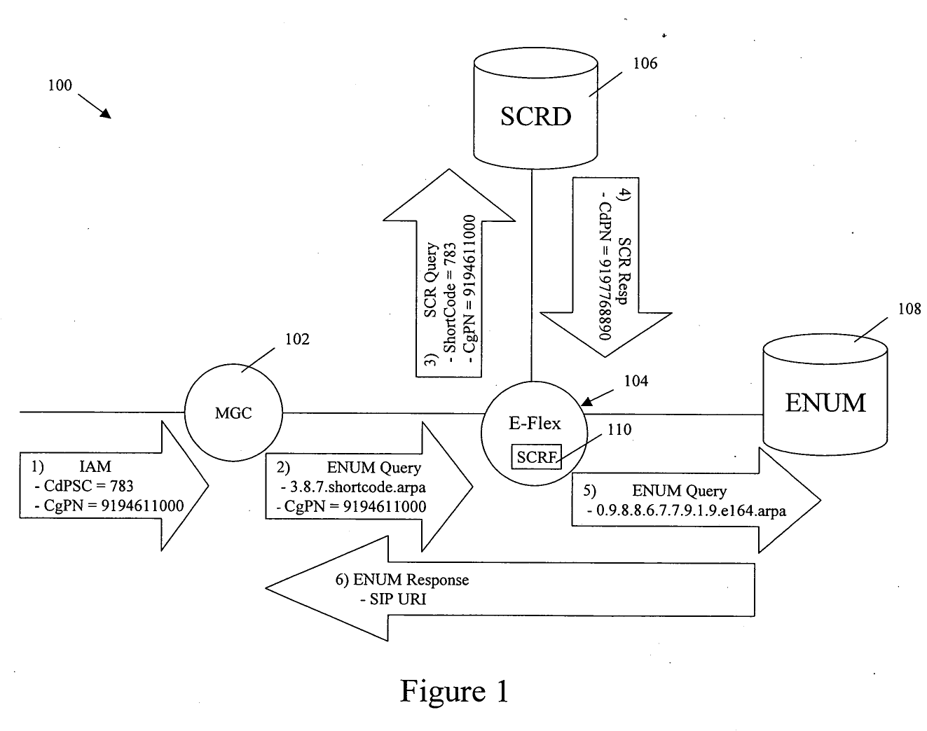

The subject matter described herein includes methods, systems, and computer program products for enabling short code dialing in an ENUM environment. Illustrated in FIG. 1 is an exemplary communications network 100, which includes a softswitch (SS) or media gateway controller (MGC) 102, a flexible ENUM (E-Flex) routing element 104, a short code resolution database (SCRD) 106, and an ENUM application 108.

MGC element 102 is adapted to receive, process, and generate call signaling messages (e.g., signaling system 7 messages, Internet Engineering Task Force SIGTRAN messages, session initiation protocol messages, bearer independent call control signaling messages, etc.) and to control bearer path setup via one or more associated media gateway elements (not shown). For example, MGC 102 may receive an SS7 ISDN user part (ISUP) Initial Address Message (IAM) call signaling message and, in response to receipt of the IAM message, generate an associated ENUM query message. It will be appreciated that the subject matter described herein is not limited to network implementations that include an MGC element, and that in other embodiments of the subject matter described herein, the MGC element 102 shown in FIG. 1 may be replaced, for example, by a mobile switching center (MSC), an MSC server, an Internet protocol multimedia subsystem (IMS) element, a Class 4/Class 5 switching office, or a circuit switched—packet gateway element.

E-Flex element 104 is adapted to receive, route, and in certain cases process ENUM query messages. More particularly, E-Flex element 104 includes a short code resolution (SCR) function 110, which is adapted to receive an ENUM query message and to determine whether the received ENUM query message is associated with a short code subscriber identifier. In response to determining that a received ENUM query message includes a short code subscriber identifier, SCR function 110 is adapted to access short code resolution database 106. In one embodiment, short code resolution database 106 includes data that maps a calling party identifier—called party short code tuple to a fully specified (e.g., E.164 formatted) called party identifier. Short code resolution database 106 may be co-located with E-Flex element 104 or may be implemented as a stand-alone element. In any event, SCR function 110 is adapted to access short code resolution database 106 using a calling party number—called party short code tuple and obtain a fully specified called party identifier. The fully specified, E.164 formatted, called party identifier value is then inserted into the ENUM query message, and the modified ENUM query message is transmitted to ENUM application 108 for ENUM translation processing.

### Exemplary E-Flex

### SCR Function Architecture

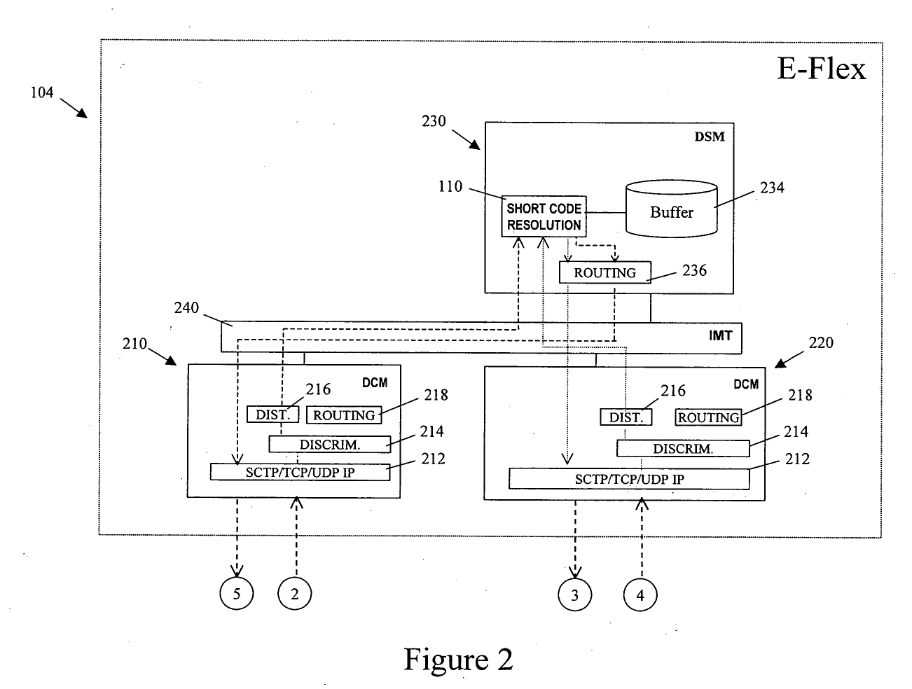

Presented in FIG. 2 is an exemplary E-Flex routing node architecture suitable for use with embodiments of the subject matter described herein. E-Flex routing node 104 includes a pair of data communication interface modules (DCMs) 210 and 220, which are adapted to transmit and receive messages to and from a communication network, such as an Internet protocol (IP) network. Communication interface modules 210 and 220 include a Transport-Network-DataLink-Physical (TNDP) protocol stack function 212 that is adapted handle inbound and outbound processing tasks associated with TNDP protocol stack layers. Exemplary TNDP protocol stack components include, but are not limited to, transmission control protocol (TCP), user datagram protocol (UDP), stream control transmission protocol (SCTP), Internet protocol (IP), asynchronous transfer mode (ATM), Ethernet, T1 and E1. A discrimination function 214 is adapted to examine an incoming message and determine whether the message requires processing by an internal subsystem, such as a short code resolution function. This discrimination may be performed by examining one or more parameters associated with a received message (e.g., message type, source address information, destination address information, or information contained in the payload portion of the message). In the event that it is determined that a received message requires processing by an SCR function, the message is passed to a message distribution function 216. Message distribution function 216 is adapted to direct or distribute the message to an application processor in the system that is configured with an SCR function. In the event that it is determined that a received message does not require processing by an internal subsystem of the E-Flex element, the message is passed to a message routing function 218. Message routing function 218 includes or has access to routing rules information that is used to route messages through a network. For example, routing function 218 may examine destination address information contained in a message and determine over which socket, association, link, or connection the message should be transmitted. Based on this information, routing function 218 is adapted to pass the message to the appropriate communication interface module for outbound transmission. In an alternate embodiment, all received messages are initially directed to an SCR function, where SCR screening/discrimination is performed.

E-Flex element 104 also includes an application processor module, DSM 230 that is configured to host the short code resolution function 110. SCR function 110 is adapted to receive an ENUM query message from a communication interface module, such as DCMs 210 and 220, and to determine whether the ENUM query message is requesting ENUM translation service for a short code subscriber identifier. If SCR function 110 determines that the ENUM query message is requesting ENUM translation service for a short code subscriber identifier, then the SCR function is adapted to extract the short code subscriber identifier and a calling party subscriber identifier from the ENUM query message and temporarily store the ENUM query message in a message buffer 234. Message buffer 234 may be implemented in random access memory (RAM) or any other suitable data storage medium (e.g., a magnetic storage medium, an optical storage medium, etc.). SCR function 110 is then adapted to use the short code subscriber identifier and a calling party subscriber identifier to access short code resolution data.

In the embodiment illustrated in FIG. 1, the short code resolution database 106 is located external to the E-Flex node 104. However, in alternate embodiments of the subject matter described herein, a short code resolution database may be integrated with or co-located with an E-Flex node. Exemplary short code resolution data is presented below in Table 1. Included in Table 1 is a calling party ID field, a called party short code field, and a called party E.164 ID field. Exemplary calling party ID values may include a wireline POTS number, a mobile subscriber ISDN (MSISDN) number, and a mobile identification number (MIN). Exemplary called party short code values may include digit sequences that are less than the length of a fully specified (e.g., POTS number, E.164 formatted number) subscriber identifier. Exemplary called party E.164 ID values include E.164 formatted subscriber identifiers. As such each calling party ID and called party short code tuple are associated with a called party E.164 subscriber identifier.

TABLE 1
Exemplary Short Code Resolution Data

| | Called Party Short | |
|---|---|---|
| Calling Party ID | Code | Called Party E.164 ID |
| 9194611000 | 783 | 9197768890 |
| 9194611000 | 12 | 2122341111 |
| 9194611000 | 363 | 9194692314 |

SCR function 110 receives a called party E.164 subscriber identifier from the short code resolution database. SCR function 110 is adapted to access the ENUM query message in message buffer 234 and to insert the called party E.164 subscriber identifier into the ENUM query message. In one embodiment the called party short code value originally specified in the ENUM query message is discarded and replaced by the called party E.164 subscriber identifier value. In an alternate embodiment, the called party E.164 subscriber identifier value is included in the ENUM query message in addition to originally specified called party short code value.

In any event, the modified ENUM query message, which includes the E.164 subscriber identifier, is then routed from the E-Flex node via routing function 236 and a communication interface module, such as a DCM module. In one embodiment, routing function 236 is adapted to map a destination address (e.g., IP address, uniform resource identifier, SS7 point code, etc.) to a communications link, association, socket, or connection and associated outbound communication interface module.

### Exemplary Message Flow

Presented in FIG. 1 is an exemplary message flow scenario associated with one embodiment of the subject matter described herein. An associated exemplary message flow internal to E-Flex node 104 is shown in FIG. 2. Beginning with message 1, a Signaling System 7 (SS7) ISDN user part (ISUP) initial address message (IAM) is received by MGC 102. IAM message 1 includes a calling party number (CgPN) identifier value of 9194611000 and called party short code (CdPSC) identifier value of 783.

In response to receiving the IAM message, MGC 102 generates an ENUM query message (message 2). ENUM query message 2 includes the CgPN identifier value 9194611000 and the CdPSC identifier value 783, where the CdPSC identifier value is represented in a reverse-dotted format (i.e., 3.8.7.shortcode.arpa). ENUM query message 2 is transmitted to E-Flex node 104. Exemplary content of ENUM query message 2 is presented below:

;; HEADER SECTION
;; id = 41555
;; qr = 0 opcode = QUERY aa = 0 tc = 0 rd = 0
;; ra = 0 ad = 0 cd = 0 rcode = NOERROR
;; qdcount = 1 ancount = 0 nscount = 0 arcount = 1
;; QUESTION SECTION (1 record)
;; 3.8.7.shortcode.arpa. IN NAPTR
;; ANSWER SECTION (0 records)
;; AUTHORITY SECTION (0 records)
;; ADDITIONAL SECTION (1 records)
CgPN = 9194611000
End of packet sent

E-Flex node 104 receives ENUM query message 2 via DCM communication module 210 and internally directs the message to DSM processor module 230, as illustrated in FIG. 2. Short code resolution function 110 is adapted to examine called party identifier contained in the query message and determine whether short code resolution processing is required. In the event that short code resolution processing is required, short code resolution function 110 extracts the called party short code identifier and calling party identifier values from the ENUM query message and temporarily stores the ENUM query message in message buffer 234. Short code resolution function 110 then generates a short code resolution query message, query message 3. The short code resolution query message includes the called party short code identifier and calling party identifier values. The short code resolution query message may, for example, be an XML formatted message. The short code resolution query message is routed to short code resolution database 106 via DCM communication module 220. Short code resolution database 106 receives query message 3 and uses the called party short code identifier and calling party identifier values to perform a lookup in a data structure that contains data similar to that illustrated above in Table 1. Database 106 returns an E.164 formatted called party identifier associated with the called party short code identifier and calling party identifier tuple. The E.164 formatted called party identifier is transmitted to the querying E-Flex node 104 via response message 4. The short code resolution response message is returned to short code resolution function 110, which in turn extracts the E.164 called party identifier from the message. The previously buffered ENUM query message (message 2) is retrieved from buffer 234 and message is modified to include the E.164 called party identifier. The modified ENUM query message (message 5) is then transmitted to ENUM database 108 where ENUM translation processing is performed and an associated ENUM response message (message 6) is generated and returned to the querying MGC 102. Exemplary content of ENUM query message 5 is presented below:

```
;; HEADER SECTION
;; id = 41555
;; qr = 0 opcode = QUERY aa = 0 tc = 0 rd = 0
;; ra = 0 ad = 0 cd = 0 rcode = NOERROR
;; qdcount = 1 ancount = 0 nscount = 0 arcount = 2
;; QUESTION SECTION (1 record)
;; 0.9.8.8.6.7.7.9.1.9.e164.arpa.  IN  NAPTR
;; ANSWER SECTION (0 records)
;; AUTHORITY SECTION (0 records)
;; ADDITIONAL SECTION (2 records)
  CgPN = 9194611000
  CdPSC = 783
End of packet sent
```

Exemplary ENUM translation data is presented in Table 2. In this example, ENUM translation data includes a called party E.164 identifier and an associated a uniform resource identifier (URI).

TABLE 2
Exemplary ENUM Data

| Called Party E.164 ID | URI |
|---|---|
| 9197768890 | SIP URI |
| 2122341111 | MAILTO URI |
| 9194692314 | IM URI |

### Integrated E-Flex

### SCR Database Embodiment

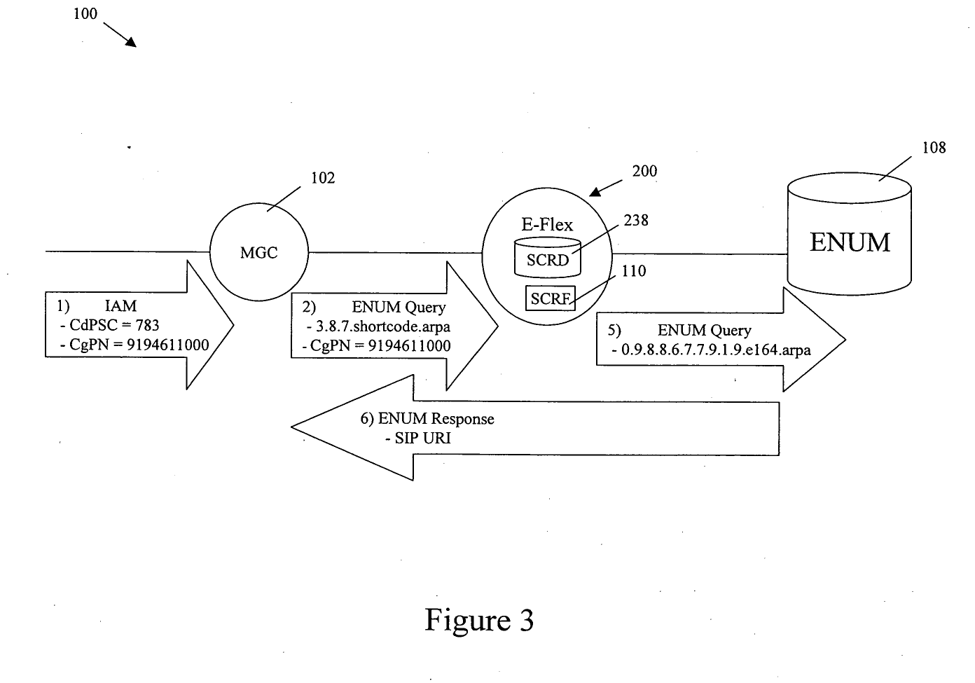

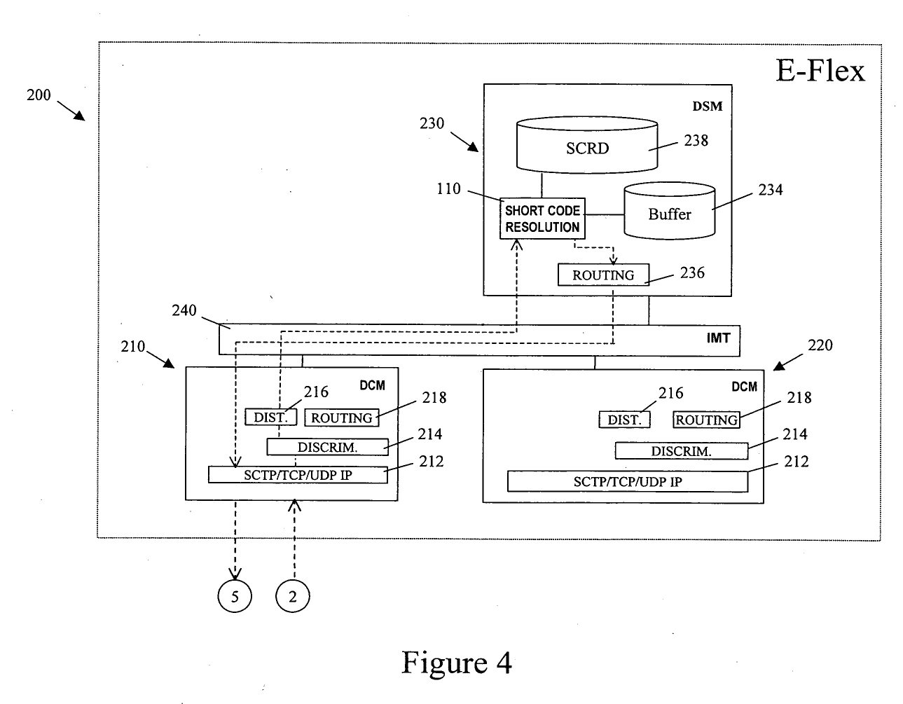

Illustrated in FIGS. 3 and 4 is an embodiment of the subject matter described herein that includes an E-Flex node with an integrated SCR database. An advantage of this embodiment is that queries to an external SCR database are not required, which may lead to improved overall system performance (e.g., decreased latency).

As shown in FIG. 3, network 100 contains an E-Flex node 200, which includes an integrated SCR database 238. E-Flex node 200 includes an SCR function 110, which provides functionality similar to that described in the previous embodiment. In this case, external SCR query and response messages 3 and 4, respectively, are eliminated. Internal SCR database 238 is accessed via a local or internal database access mechanism (e.g., SQL query/response, etc.), which does not require the generation and routing of query/response messages to and from an external SCR database. With the exception of the lack of external SCR query and response messages, the functionality and operation of the E-Flex/SCR/ENUM system is similar to that described in detail with respect to the previous embodiment. Consequently, a detailed description of system component functions and processing steps is not repeated in this section.

### ENUM Based SCR Embodiment

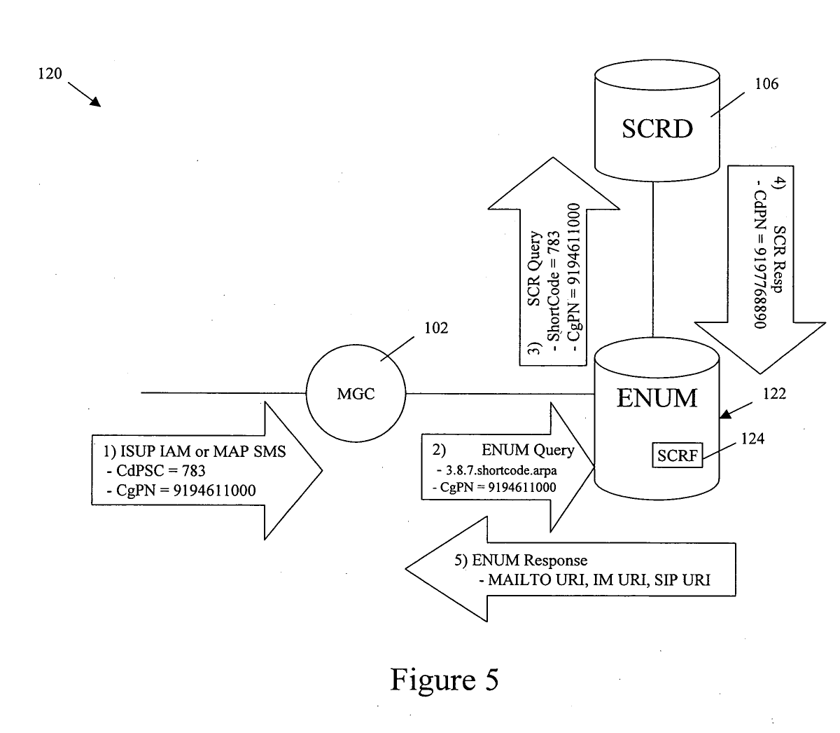

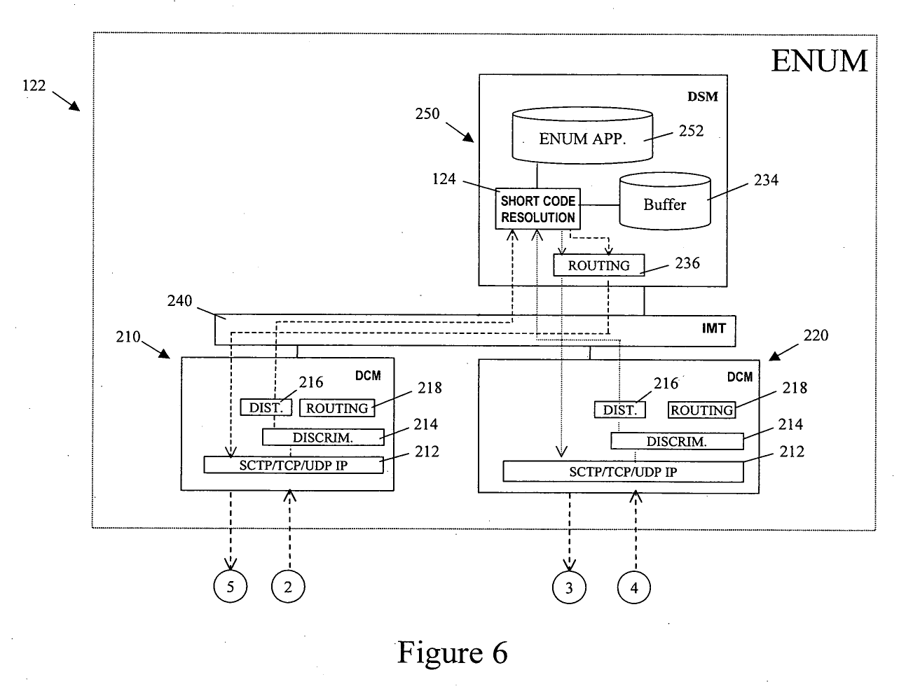

In yet another embodiment of the subject matter described herein, an SCR function that is adapted to query an SCR database is integrated with an ENUM application. Illustrated in FIG. 5 is a network 120 that includes an MGC 102, an SCR database 106, and an ENUM node 122. A block diagram of an exemplary ENUM node 122 is presented in the accompanying FIG. 6. ENUM node 122 includes communication interface modules 210 and 220 that are similar in function to those described above and an application processor module 250. Application processor module 250 includes an SCR function 124, a message buffer 234, a routing function 236, and an ENUM application 252. SCR function 124 is adapted to provide functionality similar to the previously described SCR function 110. Message buffer 234 and routing function 236 also provide functions similar to those described above. ENUM application 252 includes data similar to that illustrated in Table 2.

SCR function 124 is adapted to receive an ENUM query message that includes a calling party identifier and to determine whether the ENUM query message is requesting ENUM translation service for a short code subscriber identifier. If SCR function 124 determines that the ENUM query message is requesting ENUM translation service for a short code subscriber identifier, then SCR function 124 is adapted to extract the short code subscriber identifier and the calling party subscriber identifier from the ENUM query message and temporarily buffer the ENUM query message in message buffer 234. SCR function 124 is then adapted to use the short code subscriber identifier and a calling party subscriber identifier to access short code resolution data. Exemplary short code resolution data is illustrated above in Table 1.

In the embodiment illustrated in FIG. 5, the short code resolution database 106 is located external to the ENUM node 122. However, in alternate embodiments of the subject matter described herein, a short code resolution database may be integrated with or co-located with an ENUM application.

### Exemplary Message Flow

Beginning with message 1 shown in FIG. 5, an SS7 ISUP IAM message is received by MGC 102. IAM message 1 includes a calling party number (CgPN) identifier value of 9194611000 and called party short code (CdPSC) identifier value of 783.

In response to receiving the IAM message, MGC 102 generates an ENUM query message (message 2). ENUM query message 2 includes the CgPN identifier value 9194611000 and the CdPSC identifier value 783, where the CdPSC identifier value is represented in a reverse-dotted format (i.e., 3.8.7.shortcode.arpa). The ENUM query message 2 is transmitted to ENUM node 122. Exemplary content of ENUM query message 2 is presented below:

;; HEADER SECTION
;; id = 41555
;; qr = 0 opcode = QUERY aa = 0 tc = 0 rd = 0
;; ra = 0 ad = 0 cd = 0 rcode = NOERROR
;; qdcount = 1 ancount = 0 nscount = 0 arcount = 1
;; QUESTION SECTION (1 record)
;; 3.8.7.shortcode.arpa. IN NAPTR
;; ANSWER SECTION (0 records)
;; AUTHORITY SECTION (0 records)
;; ADDITIONAL SECTION (1 records)
CgPN = 9194611000
End of packet sent

ENUM node 122 receives ENUM query message 2, via DCM communication module 210 and internally directs the message to DSM processor module 250, as illustrated in FIG. 6. Short code resolution function 124 is adapted to examine called party identifier contained in the query message and determine whether short code resolution processing is required. In the event that short code resolution processing is required, short code resolution function 124 extracts the called party short code identifier and calling party identifier values from the ENUM query message and temporarily stores the ENUM query message in message buffer 234. Short code resolution function 124 then generates a short code resolution query message, query message 3. The short code resolution query message includes the called party short code identifier and calling party identifier values. The short code resolution query message may, for example, be an XML formatted message. The short code resolution query message is routed to short code resolution database 106, via DCM communication module 220. Short code resolution database 106 receives query message 3 and uses the called party short code identifier and calling party identifier values to perform a lookup in a data structure that contains data similar to that illustrated above in Table 1. Database 106 returns an E.164 formatted called party identifier associated with the called party short code identifier and calling party identifier tuple. The E.164 formatted called party identifier is transmitted to the querying ENUM node 122 via response message 4. The short code resolution response message is returned to short code resolution function 124. SCR function 124 provides the E.164 called party identifier to ENUM application 252. ENUM application 252 uses the E.164 called party identifier to perform a lookup in an ENUM database and returns one or more URIs corresponding to the E.164 called party number. The URI value(s) returned by ENUM application 252 are included in an ENUM response message that is associated with the buffered ENUM query message. The buffered ENUM query message is accessed and routing information contained in the ENUM query message is used to address/route the ENUM response message (message 5) to the ENUM query originator, MGC 102.

### Short Code Adapted ENUM Application Embodiment

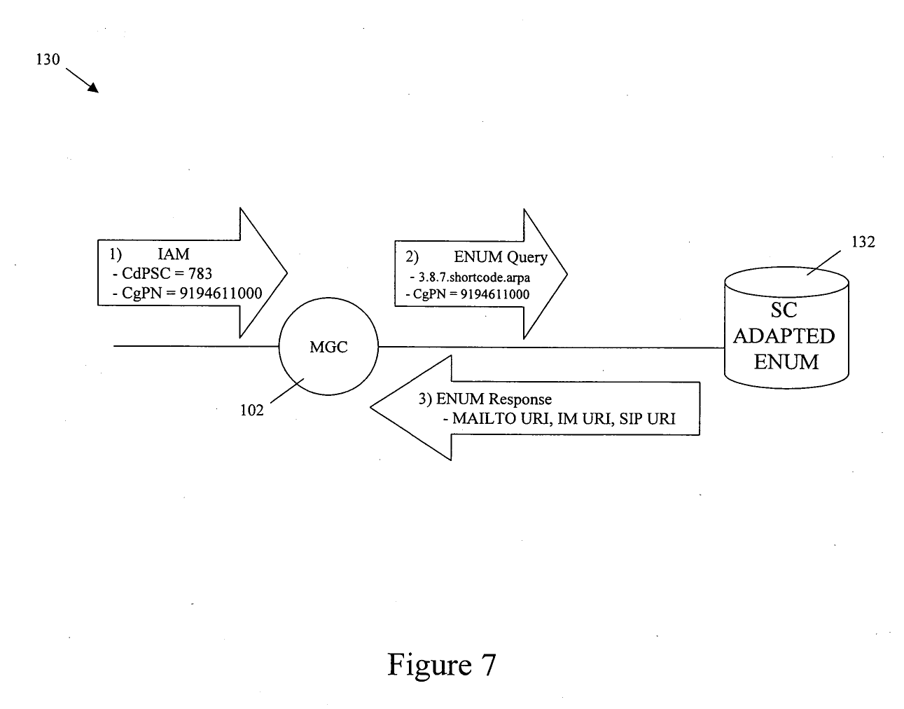

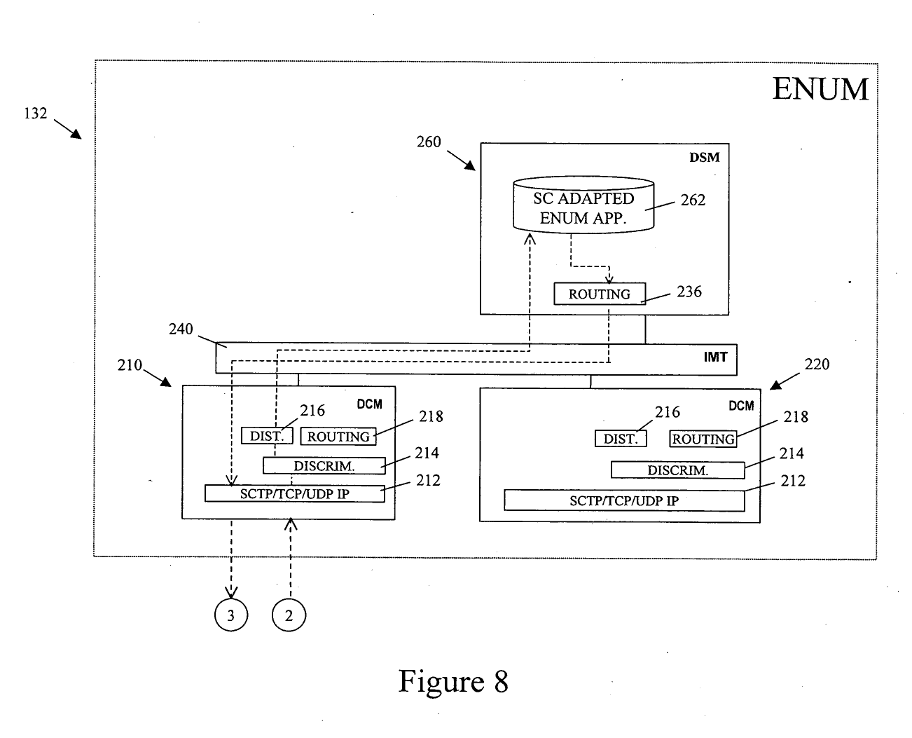

In yet another embodiment, referred to herein as a short code adapted ENUM application embodiment, an ENUM application includes an integrated SCR database, as generally illustrated in FIGS. 7 and 8. Presented in FIG. 7 is a network 130 that includes an MGC 102 and a short code adapted ENUM node 132. A block system diagram of an exemplary short code adapted ENUM node 132 is illustrated in FIG. 8. ENUM node 132 includes communication interface modules 210 and 220 that are similar in function to those described above and an application processor module 260. Application processor module 260 includes a short code adapted ENUM application 262 and a routing function 236. Short code adapted ENUM application 262 includes data similar to that illustrated above in Tables 1 and 2.

As in the examples described above, MGC 102 receives an ISUP IAM message (message 1) and subsequently generates an associated ENUM query message (message 2). Short code adapted ENUM application 262 is adapted to receive the ENUM query message (message 2) and to determine whether the ENUM query message includes a called party short code identifier. In response to determining that the ENUM query message includes a called party short code identifier, ENUM application 262 is adapted to extract the called party short code identifier and a calling party identifier from the ENUM query message and use those identifiers to locate a corresponding URI value(s).

In one embodiment, the called party short code identifier and a calling party identifier may first be resolved to an E.164 formatted identifier using SCR data similar to that illustrated above in Table 1. The resulting E.164 formatted identifier may then be used to locate a corresponding URI value(s) using ENUM translation data similar to that illustrated above in Table 2. The URI value(s) returned by short code adapted ENUM application 262 are included in an ENUM response message that is associated with the ENUM query message. Routing information contained in the ENUM query message (message 2) is used to address/route the ENUM response message (message 3) to the ENUM query originator, MGC 102.

In another embodiment, the called party short code identifier and a calling party identifier may be used by short code adapted ENUM application 262 to directly locate a corresponding URI value(s). That is, resolution of the called party short code identifier and a calling party identifier to an E.164 formatted identifier is not required. Instead, the called party short code identifier and a calling party identifier tuple may be mapped directly to one or more URI values. Such an exemplary short code adapted data structure is provided below in Table 3.

TABLE 3
Exemplary Short Code Adapted ENUM Data

| | Called Party Short | |
|---|---|---|
| Calling Party ID | Code | URI |
| 9194611000 | 783 | SIP URI |
| 9194611000 | 12 | MAILTO URI |
| 9194611000 | 363 | IM URI |

As in the embodiments described above, the URI value(s) returned by short code adapted ENUM application 262 are included in an ENUM response message that is associated with the ENUM query message. Routing information contained in the ENUM query message (message 2) is used to address/route the ENUM response message (message 3) to the ENUM query originator, MGC 102.

Although the examples described above relate to providing ENUM translations for voice communications where the called party is identified by a short code, the subject matter described herein is not limited to such embodiments. The methods, systems and computer program products described herein for providing ENUM translations may be used for any type of communications where the called party is identified by a short code. For example, the subject matter described herein may be used to perform ENUM translations for text, video, and/or audio messaging where the called party is identified using a short code.

It will be understood that various details of the subject matter described herein may be changed without departing from the scope of the invention. Furthermore, the foregoing description is for the purpose of illustration only, and not for the purpose of limitation, as the subject matter described herein is defined by the claims as set forth hereinafter.

What is claimed is:

1. A method for enabling ENUM service for communications directed to a called party short code identifier, the method comprising:
(a) receiving an ENUM query message that includes a calling party identifier and a called party short code identifier;
(b) performing an ENUM translation to locate least one URI corresponding to the calling party identifier and the called party short code identifier; and
(c) responding to the ENUM query message with the at least one URI.

2. The method of claim 1 comprising translating the calling party identifier and the called party short code identifier into an E.164 formatted called party number and wherein performing the ENUM translation includes performing the ENUM translation using the E.164 formatted called party identifier.

3. The method of claim 2 wherein translating the calling party identifier and the called party short code identifier into an E.164 formatted called party identifier includes using the calling party identifier and the called party short code identifier tuple to perform a lookup in a short code resolution database.

4. The method of claim 2 wherein performing the ENUM translation using the E.164 formatted called party identifier includes modifying the ENUM query message to include the E.164 formatted called party identifier.

5. The method of claim 4 wherein performing the ENUM translation includes transmitting the modified ENUM query message to an ENUM database.

6. The method of claim 2 wherein performing the ENUM translation using the E.164 formatted called party number includes generating a new ENUM query message that includes at least a portion of the received ENUM query message and the E.164 formatted called party identifier.

7. The method of claim 1 wherein performing the ENUM translation includes performing a lookup in an ENUM database using the calling party identifier and called party short code identifier as lookup keys.

8. A system for enabling ENUM service for communications directed to a called party short code identifier, the system comprising:
(a) a communications interface for receiving an ENUM query that includes a calling party identifier and a called party short code identifier;
(b) a short code resolution database for mapping the calling party identifier and the called party short code identifier to an E.164 formatted called party identifier; and
(c) a short code resolution function for:
(i) receiving the ENUM query from the communications interface;
(ii) for accessing the short code resolution database using the calling party identifier and called party short code identifier tuple and obtaining an associated E.164 formatted called party identifier; and
(iii) querying an ENUM database using the E.164 formatted called party identifier.

9. The system of claim 8 wherein the communication interface comprises an Internet protocol interface.

10. The system of claim 8 where the short code resolution database is co-located with the short code resolution function.

11. The system of claim 8 wherein the short code resolution function is adapted to modify the ENUM query to include the E.164 formatted called party number and to transmit the modified ENUM query to the ENUM database.

12. The system of claim 8 wherein the short code resolution function is adapted to terminate the received ENUM query and to formulate a new ENUM query including the E.164 formatted called party number.

13. The system of claim 8 wherein the short code resolution function is adapted to query an externally located short code resolution database.

14. A system for enabling ENUM service for communications directed to a called party short code identifier, the system comprising:
(a) means for receiving an ENUM query message that includes a calling party identifier and a called party short code identifier;
(b) means for performing an ENUM translation to locate least one URI corresponding to the calling party identifier and the called party short code identifier; and
(c) means for responding to the ENUM query message with the at least one URI.

15. The system of claim 14 wherein the means for receiving comprises a communications interface in a signaling node.

16. The system of claim 15 wherein the signaling node comprises one of a signal transfer point, a SIP signaling router, an ENUM server, and IMS node.

17. The system of claim 14 wherein the means for performing comprises a short code resolution function for translating the calling party identifier and the called party short code identifier into an E.164 formatted called party identifier and an ENUM translation function for translating the E.164 formatted called party identifier into the at least one URI.

18. The system of claim 14 wherein the means for performing comprises an ENUM translation function for accessing an ENUM database using the calling party identifier and the called party short code identifier as lookup keys.

19. A computer readable medium having stored thereon a short code-adapted ENUM database being accessible by an ENUM translation function to translate short code and calling party identifier combinations into URIs, the computer readable medium comprising:
(a) a memory, wherein the memory includes a short code adapted ENUM translation database accessible by an ENUM translation function to translate calling party identifier-called party short code combinations into URIs;
(b) wherein the short-code adapted ENUM translation database includes a plurality of entries, each entry including:
(i) a calling party identifier field;
(ii) a called party short code field; and
(iii) a uniform resource identifier field; and
(c) wherein the calling party identifier and called party short code fields are accessible by the ENUM translation function as indices to locate URIs corresponding to a short code-calling party identifier combination.

20. The computer-readable medium of claim 19 wherein each entry in the database includes an E.164 formatted called party field.
